(19) United States
(12) Patent Application Publication
(10) Pub. No.: US 2014/0023826 A1
(43) Pub. Date: Jan. 23, 2014

(54) COATING FILM AND METHOD FOR PRODUCING THE SAME

(71) Applicant: Fujitsu Limited, Kawasaki-shi (JP)

(72) Inventors: Fumiyo TAKEUCHI, Isehara (JP); Koichi Kimura, Atugi (JP)

(73) Assignee: Fujitsu Limited, Kawasaki-shi (JP)

(21) Appl. No.: 14/032,506

(22) Filed: Sep. 20, 2013

Related U.S. Application Data
(63) Continuation of application No. PCT/JP2011/056789, filed on Mar. 22, 2011.

(51) Int. Cl. C09D 163/00; B05D 5/00

(52) U.S. Cl. CPC C09D 163/00; B05D 5/00
USPC 428/152; 427/517; 522/31; 522/40

(57) ABSTRACT

To provide a method for producing a coating film, containing: coating a base with a coating material containing a photocurable resin, a photopolymerization initiator, and a solvent; leaving the coated base to stand for longer than 0 minutes but 20 minutes or shorter at 50° C. or lower; and then applying ultraviolet rays to the coated base to thereby produce a coating film on the base.

### CROSS-REFERENCE TO RELATED APPLICATIONS

This application is a continuation application of International Application PCT/JP2011/056789 filed on Mar. 22, 2011 and designated the U.S., the entire contents of which are incorporated herein by reference.

### FIELD

The embodiments discussed herein relate to a coating film and a method for producing a coating film, which can provide a decorative effect, as well as protection of a surface of a coating film, by applying on a housing of an electronic device, such as a laptop, and a mobile phone, and curing with ultraviolet rays.

### BACKGROUND

Coating of a housing of an electronic device, such as a mobile phone, and a laptop, is typically performed with two to four layers of coating, and is composed of an optional primer layer configured to improve adhesion to the housing, an intermediate layer to which a pigment and a luminous material are added, and a surface layer formed of a ultraviolet curable coating material, which is hard in order to protect the intermediate layer, and is resistant to chemicals and sweat. A film obtained by curing a conventional ultraviolet curable coating material for a surface layer has been glossy and smooth.

A method for forming an irregular coating film using such ultraviolet curable coating material is used for a reflector. For example, it has been disclosed that a pigment having a particle size equal to or smaller than visible light wavelength is dispersed to control transmittance of UV rays, and UV cured areas and heat cured areas are mixed (see Japanese Patent Application Laid-Open (JP-A) No. 2001-348514).

However, a surface layer obtained by the disclosed ultraviolet curable coating material has glossiness, and is smooth, and therefore has a disadvantage that finger prints and dirt are easily deposited. Moreover, as it is smooth, an electronic device, such as a mobile phone and a laptop, is slippery, and may be dropped, when it is carried.

Moreover, the irregular coating film obtained by the method where the pigment is dispersed to control transmittance of ultraviolet rays, and UV curing and thermal curing are used in combination, has a thin film thickness, and therefore such coating film lacks hardness as a surface layer of an electronic device, such as a mobile phone, and a laptop. Moreover, the convexoconcave shape is uniform and fine, and therefore a decorativeness thereof is poor, as the similar appearance can be attained by blending a delustering agent.

### SUMMARY

The disclosed method for producing a coating film contains: coating a base with a coating material containing a photocurable resin, a photopolymerization initiator, and a solvent; leaving the coated base to stand for longer than 0 minutes but 20 minutes or shorter at 50° C. or lower; and then applying ultraviolet rays to the coated base to thereby produce a coating film on the base.

In a first embodiment, the disclosed coating film is produced by the disclosed method for forming a coating film.

In a second embodiment, the disclosed coating film contains a crease pattern with convexoconcave, the coating film being obtained by the method containing: coating a base with a coating material containing a photocurable resin, a photopolymerization initiator, and a solvent; and then applying ultraviolet rays to the coated base to thereby produce the coating film on the base, wherein the crease pattern with convexoconcave has large creases and small creases, where a maximum width of each side of a region surrounded by the large creases is 1 mm to 8 mm, and the small creases are provided at an average pitch of 0.1 mm to 0.4 mm inside each region surrounded by the large creases.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a partially enlarged photograph depicting a state of a surface of the coating film of Example 1;

FIG. 2 is an enlarged schematic diagram of a crease pattern with convexoconcave of the coating film of Example 1;

FIG. 3 is a photograph depicting a state of a surface of the coating film of Comparative Example 1;

FIG. 4 is a partially enlarged photograph depicting a state of a surface of a coating film of Sample No. 1 of Example 2;

FIG. 5 is a partially enlarged photograph depicting a state of a surface of a coating film of Sample No. 2 of Example 2;

FIG. 6 is a partially enlarged photograph depicting a state of a surface of a coating film of Sample No. 3 of Example 2;

FIG. 7 is a partially enlarged photograph depicting a state of a surface of a coating film of Sample No. 4 of Example 2;

FIG. 8 is a partially enlarged photograph depicting a state of a surface of a coating film of Sample No. 5 of Example 2;

FIG. 9 is a partially enlarged photograph depicting a state of a surface of a coating film of Sample No. 6 of Example 2;

FIG. 10 is a partially enlarged photograph depicting a state of a surface of a coating film of Example 4;

FIG. 11 is a photograph depicting housings of mobile phones of 6 colors, black, blue, gray, pink, red, and white from the left, on which coating films of Example 5 have been formed, respectively;

FIG. 12 A is a diagram depicting an evaluation method of fingerprint-proof and dirt-proof in Example 5 (measurement of initial value);

FIG. 12 B is a diagram depicting an evaluation method of fingerprint-proof and dirt-proof in Example 5 (measurement of glossiness after deposition of finger prints); and

FIG. 12C is a diagram depicting an evaluation method of fingerprint-proof and dirt-proof in Example 5 (measurement of glossiness after wiping).

### DESCRIPTION OF EMBODIMENTS

### (Method for Producing Coating Film)

The disclosed method for producing a coating film contains: coating a base with a coating material containing a photocurable resin, a photopolymerization initiator, and a solvent; leaving the coated base to stand for longer than 0 minutes but 20 minutes or shorter at 50° C. or lower; and then applying ultraviolet rays to the coated base to thereby produce a coating film on the base.

In accordance with the disclosed method for producing a coating film, a large number of two types of cured creases, large and small, are formed, a crease pattern with convexoconcave composed of regions surrounded by large creases each having high height and wide width, and small creases each having low height, and aligned substantially horizontally at substantially equal pitch in each region is formed, a texture is provided, a design, which has not been seen before, such as a mother-of-peal style, and a crystal style, can be realized, and moreover, a coating film to which finger prints and dirt are hard to be deposited owing to the crease pattern with convexoconcave, and which is hard to slip can be obtained.

### <Coating Material>

The coating material contains a photocurable resin, a photopolymerization initiator, and a solvent, and may further contain other components, if necessary.

—Photocurable Resin—The photocurable resin is appropriately selected depending on the intended purpose without any limitation, and examples of the photocurable resin include: an acryl-based resin, such as epoxy acrylate, 2-hydroxyethyl(meth)acrylate, triethylene glycol di(meth)acrylate, and trimethylol propane tri(meth)acrylate; an epoxy resin, such as an alicyclic epoxy compound, a bisphenol A epoxy resin, a novolak epoxy resin, and a polygrycol epoxy resin; an epoxy-modified polymer, such as butyl glycidyl ether, phenyl glycidyl ether, 1,4-butane diol glycidyl ether, neopentyl glycol diglycidyl ether, trimethylol propane triglycidyl ether, hexahydrophthalic acid diglycidyl ester, and tetrahydrophthalic acid diglycidyl ester; and monomers and oligomers of a vinyl ether compound having an active double bond, such as triethylene glycol vinyl ether, 1,4-cyclohexane dimehanol divinyl ether, and hydroxybutyl vinyl ether. These may be used alone, or in combination. Among them, particularly preferred is an acryl-based resin, such as epoxy acrylate, 2-hydroxyethyl(meth)acrylate, triethylene glycol di(meth)acrylate, and trimethylol propane tri(meth)acrylate.

### —Photopolymerization Initiator—

The photopolymerization initiator is appropriately selected depending on the intended purpose without any limitation, and examples of the photopolymerization initiator include: a benzoin derivative; a metal arene complex; a sulfonium salt, such as triphenyl sulfonium hexafluorophosphate, and diphenylphenacyl sulfonium hexafluorophosphate; and an iodonium salt, such as diphenyl iodonium hexafluorophosphate, and bis(dodecylphenyl)iodonium hexafluoroantimonate. These may be used alone, or in combination. Among them, a benzoin derivative is particularly preferable.

An amount of the photopolymerization initiator is appropriately selected depending on the intended purpose without any limitation, but the amount of the photopolymerization initiator is preferably 0.5 parts by mass to 30 parts by mass, relative to 100 parts by mass of the photocurable resin.

### —Solvent—

The solvent is appropriately selected depending on the intended purpose without any limitation, and examples of the solvent include a hydrocarbon-based solvent, an ester-based solvent, a ketone-based solvent, an alcohol-based solvent, a halogen-based solvent, an ether-based solvent, an amide-based solvent, and a C4 or higher alkyl substituted aromatic-based solvent. A mixed solvent prepared by appropriately mixing the foregoing solvents is suitably used. Among them, particularly preferred are a hydrocarbon-based solvent, an ester-based solvent, a ketone-based solvent, an alcohol-based solvent, and a mixed solvent thereof.

Examples of the hydrocarbon-based solvent include n-decane, n-dodecane, n-tetradecane, and n-hexadecane.

Examples of the ester-based solvent include ethyl acetate, butyl acetate, isobutyl acetate, methyl ethanoate, and methyl propanoate.

Examples of the ketone-based solvent include acetone, methyl ethyl ketone, methyl isobutyl ketone, cyclopentanone, and cyclohexanone.

Examples of the alcohol-based solvent include methanol, ethanol, propanol, isopropyl alcohol, butanol, pentanol, hexanol, octanol, nonanol, cyclohexanol, methyl cellosolve, ethyl cellosolve, ethylene glycol, and benzyl alcohol.

Examples of the halogen-based solvent include dichloromethane, dichloroethane, chloroform, carbon tetrachloride, tetrachloroethane, and trichloroethane.

Examples of the ether-based solvent include dibutyl ether, tetrahydrofuran, and dioxane.

Examples of the amide-based solvent include N,N-dimethylformamide (DMF), dimethyl sulfoxide, N-methyl-2-pyrrolidone.

Examples of the C4 or higher alkyl substituted aromatic-based solvent include n-butyl benzene, cyclohexyl benzene, butyl benzene, and dodecyl benzene.

An amount of the solvent is appropriately selected depending on the intended purpose without any limitation, but the amount of the solvent is preferably 10 parts by mass to 90 parts by mass relative to 100 parts by mass of the photocurable resin.

### —Other Components—

The aforementioned other components are appropriately selected depending on the intended purpose without any limitation, and examples thereof include a surfactant, a viscosity modifier, an inorganic material, a thickener, a decomposition stabilizer, an antiseptic agent, a leveling agent, a defoaming agent, a stabilizer for preventing gelation, and reactive monomers.

### <Base>

A shape, structure, size and material of the base are appropriately selected depending on the intended purpose without any limitation. Examples of the shape of the base include a plate shape. As for the structure of the base, the structure may be a single layer structure, or a laminate structure. The size of the base can be appropriately selected depending on the intended use.

A material of the base is appropriately selected depending on the intended purpose without any limitation, and examples of the material thereof include: an inorganic material, such as glass (e.g., non-alkali glass, and soda-lime glass); polyester, such as polyethylene terephthalate (PET), and polyethylene naphthalate; polyolefine, such as polyethylene (PE), polypropylene (PP), polystyrene, and EVA; a vinyl-based resin, such as polyvinyl chloride, and polyvinylidene chloride; polyether ether ketone (PEEK); polysulfone (PSF); polyethersulfone (PES); polycarbonate (PC); polyamide; polyimide; an acrylic resin; and triacetyl cellulose (TAC). These may be used alone, or in combination.

As for the base, for example, a housing of an electronic device, such as a laptop, and a mobile phone, is particularly preferable.

### <Coating Method>

A coating method of the base with the coating material is appropriately selected depending on the intended purpose without any limitation, and examples of the coating method include bar coating, spray coating, curtain coating, spin coating, gravure coating, inkjet coating, and dip coating.

The average thickness of a coating film formed on the base by the aforementioned coating method is preferably 10 μm to 50 μm. When the average thickness of the coating film is greater than 50 μm, evaporation of the solvent from the coating film is insufficient, which may result in a soft coating film. When the average thickness of the coating film is less than 10 μm, adhesion of the coating film may be insufficient.

### <Standing>

After coating the base with the coating material followed by leaving to stand for longer than 0 minutes but 20 minutes or shorter at 50° C. or lower, ultraviolet rays are applied, and the resultant is preferably left to stand for longer than 0 minutes but 15 minutes or shorter at 15° C. to 35° C.

The temperature for standing is higher than 50° C., a polygonal shape formed with a large crease may be clasped so that a crease pattern with convexoconcave may not be formed. When the duration for standing at 50° C. or lower is longer than 20 minutes, a large amount of the solvent is evaporated from the coating film, and as a result, the coating film may not be cracked by contraction so that it may be difficult to recognize a crease pattern with convexoconcave.

### <Application of Ultraviolet Rays>

The application of ultraviolet rays is appropriately selected depending on the intended purpose without any limitation, and for example, the application of ultraviolet rays is preferably performed by means of a ultraviolet lamp at 800 mJ/cm² or lower for 1 minute to 20 minutes, more preferably at 300 mJ/cm² to 600 mJ/cm² for 1 minute to 10 minutes. When the application of the ultraviolet rays is greater than 800 mJ/cm², the base on which the coating film has been formed may be deformed with heat generated during the application of ultraviolet rays.

After the application of ultraviolet rays, the coating film is preferably dried. The drying is appropriately selected depending on the intended purpose without any limitation, but for example, the drying is preferably performed at 80° C. or higher for 10 minutes or longer. As a result of the drying, the solvent is completely evaporated, and the resin is completely cured.

### (Coating Film)

The disclosed coating film is produced by the disclosed method for forming a coating film.

The disclosed coating film has a crease pattern with convexoconcave formed by coating a base with a coating material containing a photocurable resin, a photopolymerization initiator, and a solvent, and applying ultraviolet rays.

The crease pattern with convexoconcave has large creases and small creases. The large creases are formed by, after leaving the coated coating film to stand at room temperature to thereby form a thin film at a surface layer, applying ultraviolet rays to forcefully contract the coating film to thereby crack the thin film of the surface layer and form large creases each having a high height and wide width. Subsequently, the coating film is dried with hot air. As a result, the solvent is completely evaporated, and the resin is completely cured. During the complete curing, small creases each having a low height and aligned substantially horizontally with substantially the equal pitch are further formed inside each region surrounded by the large crease having a high height and wide width.

The maximum width of each side of the region surrounded by the large creases is 1 mm to 8 mm, and inside each region surrounded by the large creases, the small creases are provided at the average pitch of 0.1 mm to 0.4 mm.

Here, “the maximum width LB of each side of the region surrounded by the large creases” and “the average pitch LS of the small creases” depicted in FIG. 2 can be measured, for example, by observing an enlarged view of the coating film using a digital microscope (VHX-1000, manufactured by Keyence Corporation), and measuring using an image measurement function.

The coating film having the crease pattern with convexoconcave is preferably transparent, as a coating color of an under layer can be seen, and an appearance having an excellent design can be obtained. Here, the coating film being transparent means that the coating film has the transmission factor of 50% or greater to all rays of light, preferably 80% or greater, and more preferably 90% or greater.

The average thickness of the convex portions is preferably 10 μm to 50 μm.

The pencil hardness of the coating film in accordance with JIS K5600-5-4 is preferably “H” or harder, more preferably “2H” or harder. When the pencil hardness is lower than “H,” for example in the case where the coating film is applied on a housing of a laptop or a mobile phone, a surface of the coating is easily scratched during use (carrying), which may impair the appearance. In the case where the coating film is applied to an equipment, which is used still, such as a television, and an air conditioner, however, the requirement for the pencil hardness may be lower compared to the equipment used mobile, such as a laptop, and a mobile phone.

### (Electronic Device)

The disclosed electronic device is not particularly limited as long as the electronic device has the disclosed coating, and a shape, structure, and size of the electronic device are appropriately selected.

The electronic device is appropriately selected depending on the intended purpose without any limitation, and examples thereof include a personal computer (e.g., a laptop personal computer, and a desk top personal computer), a phone, a mobile phone, a photocopier, a facsimile, various printers, a digital camera, a television, a video player, a CD device, a DVD device, an air conditioner, and a remote controller. Among them, a laptop, and a mobile phone are particularly preferable as they are used mobile.

Moreover, due to a crease pattern with convexoconcave of the disclosed coating film, finger prints and dirt are hardly deposited to the disclosed electronic device, and the disclosed electronic device is hardly slipped, and therefore, for example, a coating film can be formed only back surface or side surface of a housing of a mobile phone.

In accordance with the disclosed coating film and the disclosed method for producing a coating film, the coating film has a crease pattern with convexoconcave, gives a texture, and realizes a design, which has not been seen before, such as a mother-of-pearl style, and a crystal style, as well as attaining an effect that finger prints and dirt are hardly deposited and a resulting object or equipment is less slippery due to a crease pattern with convexoconcave.

### EXAMPLES

The disclosed examples will be explained hereinafter, but the disclosed technique is not limited to these examples.

### Example 1

A ultraviolet ray curable coating material was prepared by blending 100 parts by mass of epoxy acrylate (U-PICA EPA8351, manufactured by Japan U-PICA Company, Ltd.) as a photocurable resin, 10 parts by mass of benzoin derivative (B0079, manufactured by Tokyo Chemical Industry Co., Ltd.) as a photopolymerization initiator, and 70 parts by mass of the following solvent.

### —Solvent—

The solvent included toluene (33.2% by mass), ethyl acetate (3% by mass to 5% by mass), butyl acetate (15% by mass to 20% by mass), isobutyl alcohol (5% by mass to 10% by mass), methyl isobutyl ketone (5% by mass to 10% by mass), cyclohexanone (5% by mass to 10% by mass), ethylene glycol monobutyl ether (10% by mass to 15% by mass), and ethyl alcohol (1% by mass to 3% by mass).

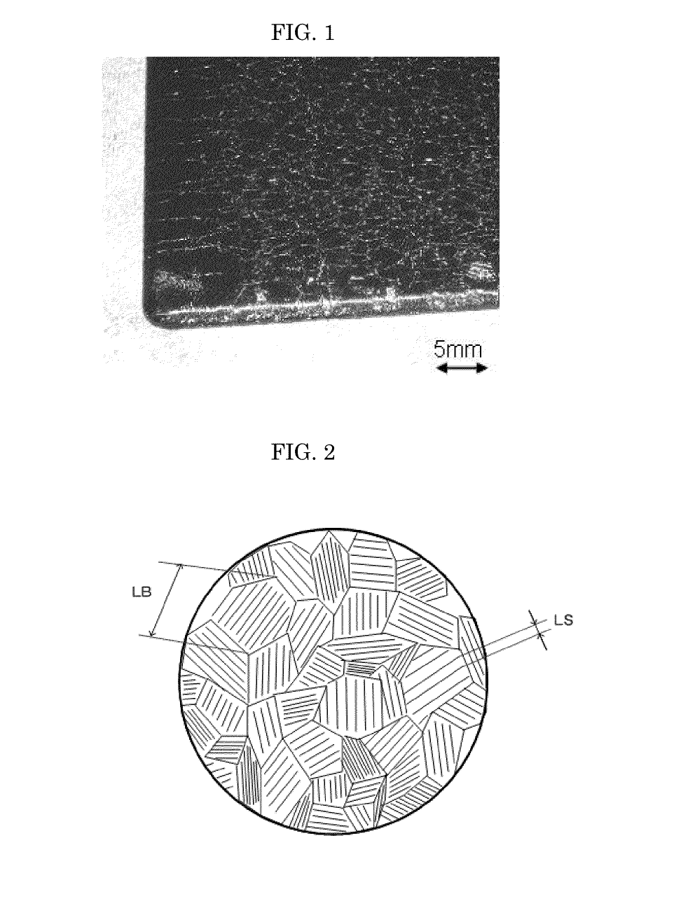

The obtained coating material was applied onto a housing of a mobile phone, to which an undercoat had been provided, by spray coating to give a thickness of 15 μm. The resultant was left to stand at 25° C. for 5 minutes to evaporate 20% by mass of the solvent, to thereby form a thin film at a surface layer. Next, ultraviolet rays of 500 mJ/cm² was applied for 5 minutes using a UV lamp (Type: H06-L31, 6 kW, manufactured by EYE GRAPHICS CO., LTD.), to forcefully contract the coating film. As a result, the thin film of the surface layer was cracked to thereby form large creases each having high height and wide width. Thereafter, the coating film was dried with hot air at 80° C. for 20 minutes. As a result, the solvent was completely evaporated, and the resin was completely cured. During the complete curing, inside each region surrounded by the large creases having high height and wide width, small creases having small height and aligned substantially horizontally at a substantially equal pitch within each region were formed. A state of the surface of the obtained coating film is depicted in FIG. 1. Moreover, an enlarged schematic diagram of the crease pattern with convexoconcave of the coating film of FIG. 1 is depicted in FIG. 2.

### Comparative Example 1

A ultraviolet ray curable coating material was prepared by blending 100 parts by mass of epoxy acrylate (U-PICA EPA8351, manufactured by Japan U-PICA Company, Ltd.) as a photocurable resin, 10 parts by mass of a benzoin derivative (B0079, manufactured by Tokyo Chemical Industry Co., Ltd.) by a photopolymerization initiator, and 70 parts by mass of the following solvent.

—Solvent—

The solvent included toluene (33.2% by mass), ethyl acetate (3% by mass to 5% by mass), butyl acetate (15% by mass to 20% by mass), isobutyl alcohol (5% by mass to 10% by mass), methyl isobutyl ketone (5% by mass to 10% by mass), cyclohexanone (5% by mass to 10% by mass), ethylene glycol monobutyl ether (10% by mass to 15% by mass), and ethyl alcohol (1% by mass to 3% by mass).

The obtained coating material was applied onto a housing (ABS resin) of a mobile phone, to which an undercoat had been provided, by spray coating to give a thickness of 15 μm. The resultant was kept at 80° C. for 10 minutes to evaporate 80% by mass of the solvent, to thereby obtain a smooth coating film.

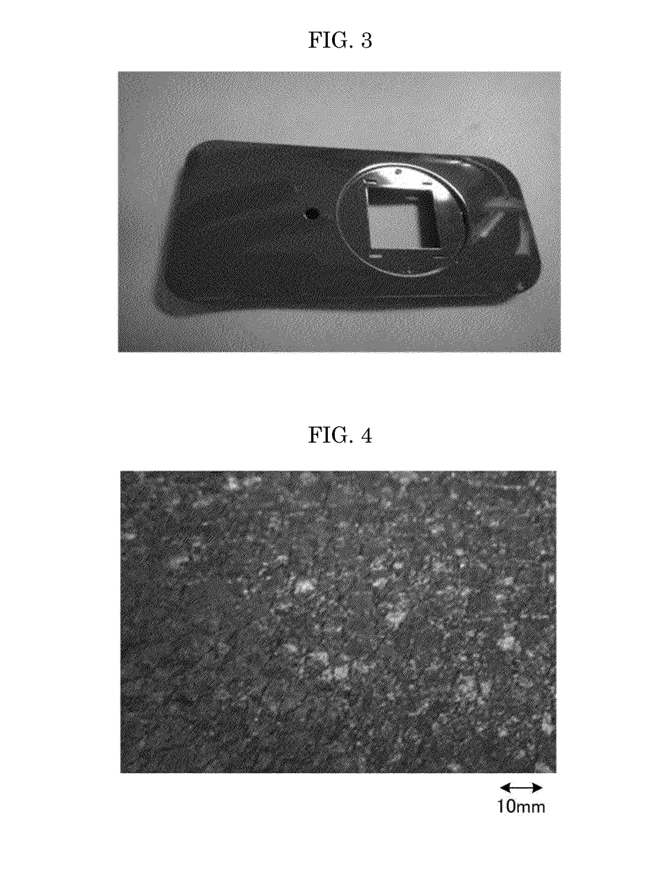

Next, to the obtained coating film, ultraviolet rays of 500 mJ/cm² was applied for 5 minutes using a UV lamp (Type: H06-L31, 6 kW, manufactured by EYE GRAPHICS CO., LTD.), to thereby completely cure the resin. A state of the surface of the obtained coating film is depicted in FIG. 3.

Next, the coating films of Example 1 and Comparative Example 1 were subjected to the evaluations of “maximum width of each side of the region surrounded by large creases, and the average pitch of small creases,” “pencil hardness,” and “adhesion” in the following manner. The results are presented in Table 1.

### <Measurements of Maximum Width of Each Side of Region Surrounded by Large Creases, and Average Pitch of Small Creases>

The “the maximum width LB of each side of the region surrounded by large creases” and “the average pitch LS of small creases” illustrated in FIG. 2 were measured by observing an enlarged view of the coating film under a digital microscope (VHX-1000, manufactured by Keyence Corporation), and measuring the “the maximum width LB of each side of the region surrounded by large creases” and “the average pitch LS of small creases” using an image measuring function.

### <Pencil Hardness>

The pencil hardness of the coating film was measured in accordance with a pencil hardness test specified in JIS K5600-5-4.

The pencil hardness is ranked as “6B,” “5B,” “4B,” “3B,” “2B,” “HB,” “F,” “2H,” “3H,” “4H,” “5H”, and “6H” in the order from soft to hard. The hardest pencil hardness with which scratches were not formed was determined as the pencil hardness of the coating film. In the present specification, the pencil hardness of “H” or harder was regarded as acceptable.

### <Adhesion>

The adhesion of the coating film was evaluated based on the cross-cut test specified in JIS K5600.

A grid pattern of right angle (100 squares) was formed on the coating film so that the cut reached to the base, and an adhesive tape (CELLOTAPE (registered trade mark), manufactured by NICHIBAN CO., LTD., 18 mm-width) was bonded to the grid pattern. One to two minutes after the adhesive tape was adhered, an edge of the adhesive tape was held at a right angle from the coating film surface, and peeled off immediately. The adhesion of the coating film was evaluated based on the number of the squares remained without being peeled out of the 100 squares.

A state where there was no peeling in all the square (=100/100) was regarded as acceptable, and a state where peeling occurred even with one square was regarded as unacceptable.

TABLE 1

| | Example 1 | Comparative Example 1 |
|---|---|---|
| Photocurable resin | epoxy acrylate | epoxy acrylate |
| | (100 parts by mass) | (100 parts by mass) |
| Photopolymerization | benzoin derivative | benzoin derivative |
| initiator | (10 parts by mass) | (10 parts by mass) |
| Solvent | 70 parts by mass | 70 parts by mass |
| Average thickness of | 15 μm | 15 μm |
| coating film | | |
| Standing before | at 25° C. for 5 minutes | at 80° C. for 10 minutes |
| application of UV rays | (solvent evaporation | (solvent evaporation |
| | amount: 20% by mass) | amount: 80% by mass) |
| Application of UV rays | applying UV of 500 | applying UV of 500 |
| | mJ/cm² for 5 minutes | mJ/cm² for 5 minutes |
| Drying | at 80° C. for 20 minutes | N/A |
| Maximum width of | 2 mm to 4 mm | N/A (glossy and smooth |
| polygon of large creases | | coating film) |
| Average pitch of small | 0.1 mm to 0.15 mm | |
| creases | | |
| Pencil hardness | H or harder | H or harder |
| Adhesion | 100/100 | 100/100 |

It was found from the results depicted in Table 1 that the maximum width LB of each side of the region (polygon) surrounded by the large creases was 2 mm to 4 mm, and the average pitch LS of the small creases was 0.1 mm to 0.15 mm in Example 1.

In Comparative Example 1, the coating film having glossiness, being smooth, and being hard with pencil hardness of “H” or higher was obtained by curing. However, the coating film of Comparative Example 1 had disadvantages that finger prints and dirt were visible as deposited, and it was slippery.

### Example 2

A ultraviolet ray curable coating material was prepared by blending 100 parts by mass of an alicyclic epoxy compound (Celloxide 202, manufactured by Daicel Corporation) as a photocurable resin, 10 parts of a cationic photopolymerization initiator (IRGACURE 250, manufactured by BASF), and 70 parts by mass of the following solvent.

### —Solvent—

The solvent included toluene (33.2% by mass), ethyl acetate (3% by mass to 5% by mass), butyl acetate (15% by mass to 20% by mass), isobutyl alcohol (5% by mass to 10% by mass), methyl isobutyl ketone (5% by mass to 10% by mass), cyclohexanone (5% by mass to 10% by mass), ethylene glycol monobutyl ether (10% by mass to 15% by mass), and ethyl alcohol (1% by mass to 3% by mass).

The obtained coating material was applied onto a housing (ABS resin) of a mobile phone, to which an undercoat had been provided, by spray coating to give a thickness of 15 μm. The resultant was left to stand at 25° C. with varying the time, i.e., for 0 minutes, 1 minute, 5 minutes, 15 minutes, and 20 minutes, to evaporate the solvent. Thereafter, ultraviolet rays of 500 mJ/cm² was applied for 5 minutes using a UV lamp (Type: H06-L31, 6 kW, manufactured by EYE GRAPHICS CO., LTD.), to forcefully contract the coating film, followed by drying with hot air at 80° C. for 10 minutes. As a result, during the standing time of 0 minutes to 15 minutes before the application of ultraviolet rays, inside each region surrounded by the large creases having high height and wide width, small creases having small height and aligned substantially horizontally at a substantially equal pitch within each region were formed similarly to Example 1. In the manner as mentioned, the coating films of Nos. 1 to 5 were produced.

A coating film of No. 6 was produced in the same manner as in Nos. 1 to 5, provided that the obtained coating material was applied onto a housing (ABS resin) of a mobile phone, to which an undercoat had been provided, by spray coating to give a thickness of 15 μm, and the resultant was maintained at 80° C. for 3 minutes to evaporate 75% by mass of the solvent. States of the surfaces of the coating films of Nos. 1 to 6 are depicted in FIGS. 4 to 9, respectively.

Next, the produced coating films of Nos. 1 to 6 were subjected to the evaluations of “maximum width of each side of the region surrounded by large creases, and the average pitch of small creases,” “pencil hardness,” and “adhesion” in the same manner as in Example 1. The results are presented in Table 2.

TABLE 2-1

| | Example 2 |
|---|---|
| Photocurable resin | alicyclic epoxy compound |
| | (100 parts by mass) |
| Photopolymerization | cationic photopolymerization initiator |
| initiator | (10 parts by mass) |
| Solvent | 70 parts by mass |
| Coating method | spray coating |
| Average thickness of | 15 μm |
| coating film | |
| Standing before | see Table 2-2 |
| application of UV rays | |
| Application of UV | applying UV of 500 mJ/cm² for 5 minutes |
| rays | |
| Drying | at 80° C. for 10 minutes |

TABLE 2-2

| | | Solvent | | |
|---|---|---|---|---|
| | | evaporation | Maximum | |
| | | amount | width of | Average pitch |
| | Standing | (% by | polygon of | of small |
| No. | conditions | mass) | large creases | creases |
| 1 | at 25° C. | 0 | 3 mm to 5 mm | 0.2 mm to 0.4 mm |
| | for 0 minutes | | | |
| 2 | at 25° C. | 10 | 3 mm to 4 mm | 0.2 mm to 0.3 mm |
| | for 1 minute | | | |
| 3 | at 25° C. | 20 | 2 mm to 4 mm | 0.1 mm to 0.15 mm |
| | for 5 minutes | | | |
| 4 | at 25° C. | 35 | 1 mm to 2 mm | 0.05 mm to 0.1 mm |
| | for 15 minutes | | | |
| 5 | at 25° C. | 55 | Impossible to | Difficult to judge, |
| | for 20 minutes | | judge | up to 0.05 mm |
| 6 | at 80° C. | 75 | Impossible to | Small creases are |
| | for 3 minutes | | judge | curved, there is a |
| | | | | mixture of a |
| | | | | part where there |
| | | | | are creases, and a |
| | | | | part where |
| | | | | there is no crease. |

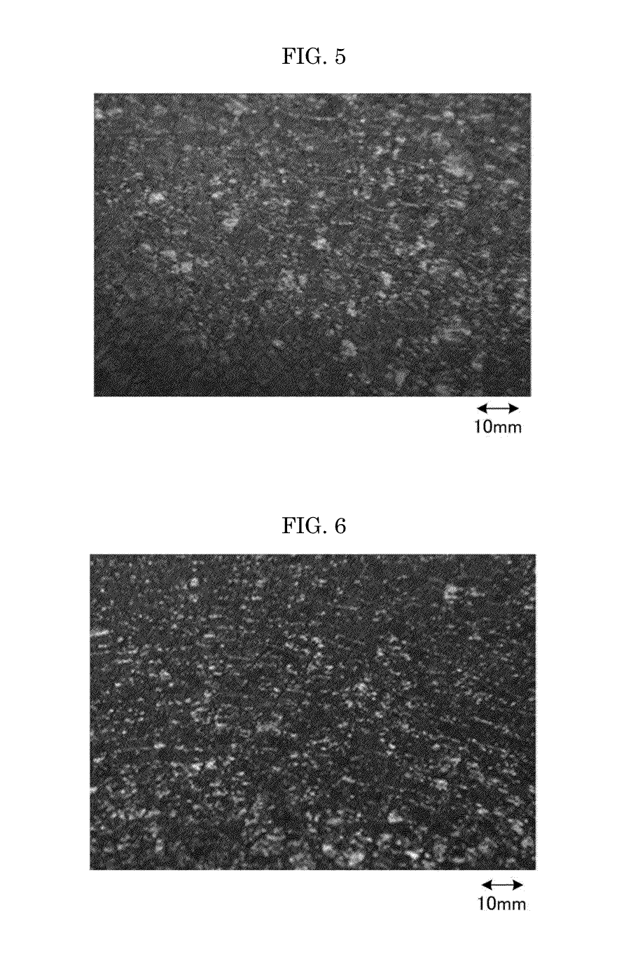

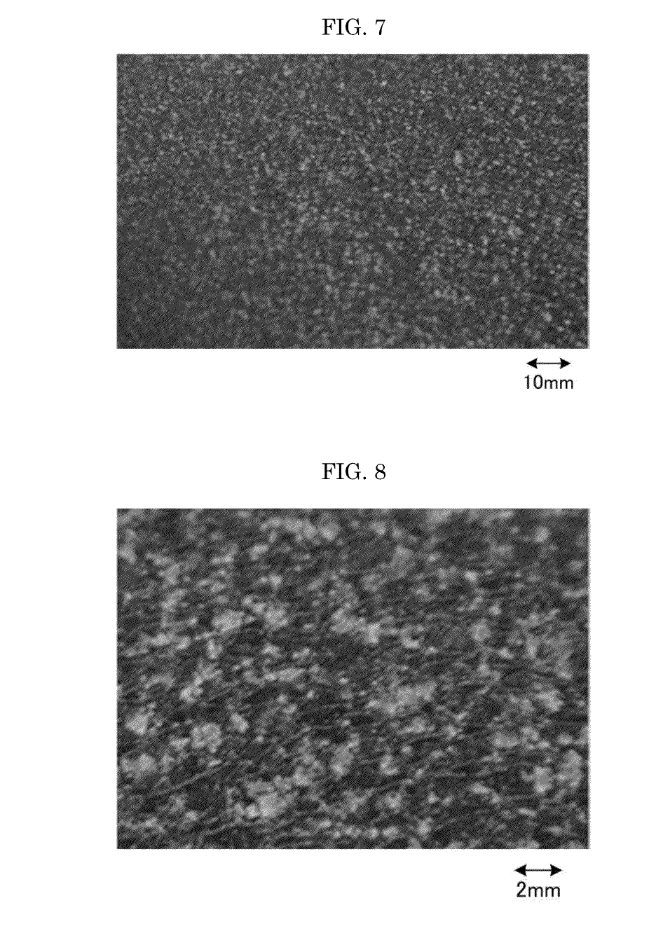

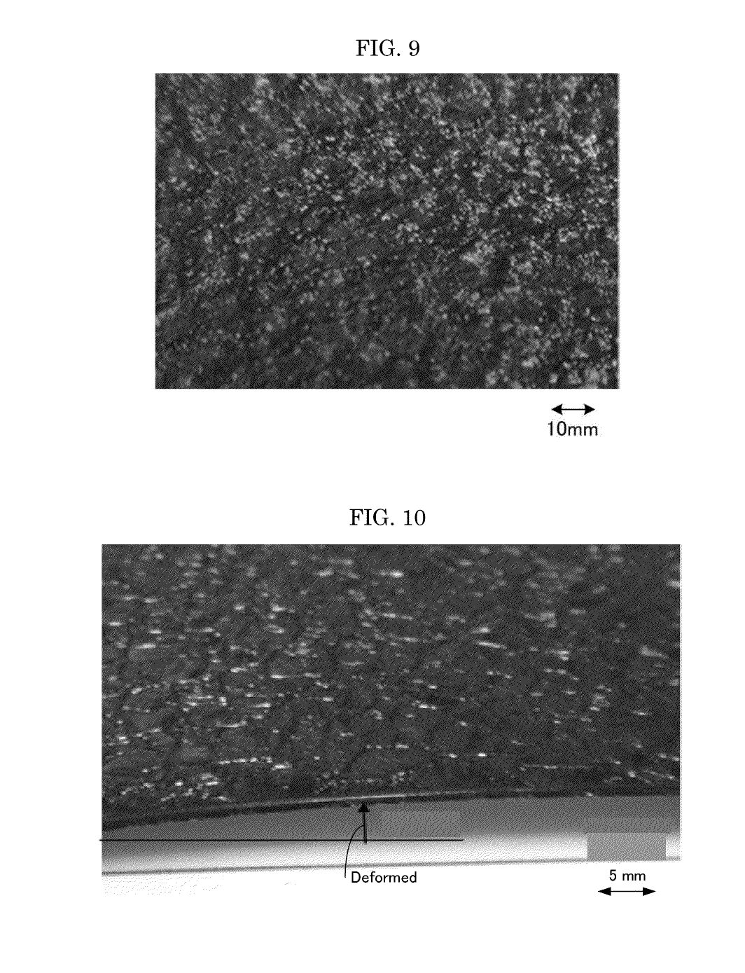

TABLE 2-3

| | | | Figure |
|---|---|---|---|
| | | | depicting state |
| | Pencil | | of surface of |
| No. | Hardness | Adhesion | coating film |
| 1 | B to HB | 100/100 | FIG. 4 |
| 2 | H | 100/100 | FIG. 5 |
| 3 | H | 100/100 | FIG. 6 |
| 4 | H | 100/100 | FIG. 7 |
| 5 | H | 100/100 | FIG. 8 |
| 6 | H | 100/100 | FIG. 9 |

As seen in the results depicted in Table 2, in the coating film of No. 3, the maximum LB of each side of the region (polygon) surrounded by the large creases was 2 mm to 4 mm, and the average pitch of the small creases was 0.1 mm to 0.15 mm. It was found that, the maximum width of each side of the region (polygon) surrounded by the large creases became large, and the average pitch of the small creases became large similarly, as the retention time was shortened.

Nos. 2 to 6 could achieve the hardness H, which was required for a coating surface of an electronic device, in the pencil hardness test. Moreover, Nos. 2 to 6 had no peeling in the adhesion test (cross-cut test), and it was found out that Nos. 2 to 6 had sufficient adhesion.

No. 1 had the pencil hardness of “B” to “HB.” It was considered that this result was caused by insufficient evaporation of the solvent from the coating film.

When the standing time was long, as in No. 5, moreover, the amount of the solvent evaporated from the coating film increased, and therefore the coating film was not cracked by contraction, which made it difficult to recognize the pattern.

When the coating film was left to stand for 3 minutes in the atmosphere of 80° C. as in No. 6, moreover, a polygon of the large creases was clasped, and therefore a pattern could not be formed.

### Example 3

A ultraviolet ray curable coating material was prepared by blending 100 parts by mass of epoxy acrylate (U-PICA EPA8351, manufactured by Japan U-PICA

Company, Ltd.) as a photocurable resin, 10 parts by mass of a benzoin derivative (B0079, manufactured by Tokyo Chemical Industry Co., Ltd.) as a photopolymerization initiator, and 70 parts by mass of the following solvent.

### —Solvent—

The solvent included toluene (33.2% by mass), ethyl acetate (3% by mass to 5% by mass), butyl acetate (15% by mass to 20% by mass), isobutyl alcohol (5% by mass to 10% by mass), methyl isobutyl ketone (5% by mass to 10% by mass), cyclohexanone (5% by mass to 10% by mass), ethylene glycol monobutyl ether (10% by mass to 15% by mass), and ethyl alcohol (1% by mass to 3% by mass).

The obtained coating material was applied onto a housing of a mobile phone, to which an undercoat had been provided, by spray coating to give a thickness of 5 μm, 10 μm, 30 μm, 50 μm, and 100 μm, respectively, with varying a thickness. The resultant was left to stand at 25° C. for 5 minutes, to thereby form a thin film at a surface layer. Next, ultraviolet rays of 500 mJ/cm² was applied for 5 minutes using a UV lamp (Type: H06-L31, 6 kW, manufactured by EYE GRAPHICS CO., LTD.), to forcefully contract the coating film. As a result, the thin film of the surface layer was cracked to thereby form large creases each having high height and wide width. Thereafter, the coating film was dried with hot air at 80° C. for 20 minutes. As a result, the solvent was completely evaporated, and the resin was completely cured. During the curing, inside each region surrounded by the large creases having high height and wide width, small creases having small height and aligned substantially horizontally at a substantially equal pitch within each region were formed. In the manner described above, coating films of Nos. 7 to 11 were produced.

Next, the produced coating films of Nos. 7 to 11 was subjected to the evaluations of “maximum width of each side of the region surrounded by large creases, and the average pitch of small creases,” “pencil hardness,” and “adhesion” in the same manner as in Example 1. The results are presented in Table 3.

TABLE 3-1

| | Example 3 |
|---|---|
| Photocurable resin | epoxy acrylate (100 parts by mass) |
| Photopolymerization | benzoin derivative (10 parts by mass) |
| initiator | |
| Solvent | 70 parts by mass |
| Coating method | spray coating |
| Average thickness of | See Table 3-2 |
| coating film | |
| Standing before | at 25° C. for 5 minutes (solvent evaporation |
| application of UV rays | amount: 20% by mass) |
| Application of UV rays | applying UV of 500 mJ/cm² for 5 minutes |
| Drying | at 80° C. for 20 minutes |

TABLE 3-2

| | Average | Maximum width | Average | Solvent | | |
|---|---|---|---|---|---|---|
| | thickness of | of polygon | pitch of | evaporation | | |
| | coating film | of large | small | amount | Pencil | |
| No. | (μm) | creases | creases | (% by mass) | hardness | Adhesion |
| 7 | 100 | 3 mm to 5 mm | 0.2 mm to 0.4 mm | 20 | 2B to HB | 100/100 |
| 8 | 50 | 3 mm to 5 mm | 0.2 mm to 0.4 mm | 20 | H or harder | 100/100 |
| 9 | 30 | 3 mm to 4 mm | 0.2 mm to 0.3 mm | 20 | H or harder | 100/100 |
| 10 | 10 | 2 mm to 4 mm | 0.1 mm to 0.15 mm | 20 | H or harder | 100/100 |
| 11 | 5 | 1 mm to 2 mm | 0.05 mm to 0.1 mm | 20 | H or harder | 95/100 |

It was found from the results of Table 3 that the maximum width LB of each side of the region (polygon) surrounded by the large creases and the average pitch LS of the small creases were different depending on the average thickness of the coating film. Specifically, the maximum width of each side of the region (polygon) surrounded by the large creases became large, and the average pitch of the small creases became similarly large, as the average thickness of the coating film became thick.

Nos. 8 to 10 could achieve the hardness H, which was required for a coating surface of an electronic device, in the pencil hardness test. Moreover, Nos. 8 to 10 had no peeling in the adhesion test (cross-cut test), and it was found out that Nos. 8 to 10 had sufficient adhesion.

Moreover, No. 7 had the pencil hardness of “2B” to “HB.” It was considered that this result is caused by that the resin was not completely cured as the evaporation of the solvent was insufficient.

Moreover, No. 11 had a thin coating film, i.e., the average thickness of 5 μm, and thus 5 squares were peeled in the adhesion test (cross-cut test).

### Example 4

A ultraviolet ray curable coating material was prepared by blending 100 parts by mass of an alicyclic epoxy compound (Celloxide 202, manufactured by Daicel Corporation) as a photocurable resin, 10 parts of a cationic photopolymerization initiator (IRGACURE 250, manufactured by BASF), and 70 parts by mass of the following solvent.

### —Solvent—

The solvent included toluene (33.2% by mass), ethyl acetate (3% by mass to 5% by mass), butyl acetate (15% by mass to 20% by mass), isobutyl alcohol (5% by mass to 10% by mass), methyl isobutyl ketone (5% by mass to 10% by mass), cyclohexanone (5% by mass to 10% by mass), ethylene glycol monobutyl ether (10% by mass to 15% by mass), and ethyl alcohol (1% by mass to 3% by mass).

The obtained coating material was applied onto a housing (ABS resin) of a mobile phone, to which an undercoat had been provided, by spray coating to give a thickness of 15 μm. The resultant was left to stand at 25° C. for 5 minutes to evaporate 75% by mass of the solvent. After evaporating the solvent, ultraviolet rays of 1,000 mJ/cm² was applied for 5 minutes using a UV lamp (Type: H06-L31, 6 kW, manufactured by EYE GRAPHICS CO., LTD.), to forcefully contract the coating film. The resultant was dried with hot air at 80° C. for 10 minutes. A state of the surface of the obtained coating film is depicted in FIG. 10. In the manner described above, the coating film of Example 4 was produced.

Next, the produced coating film of Example 4 was subjected to the evaluations of “maximum width of each side of the region surrounded by large creases, and the average pitch of small creases,” “pencil hardness,” and “adhesion” in the same manner as in Example 1. The results are presented in Table 4.

TABLE 4

| | Example 4 |
|---|---|
| Photocurable resin | alicyclic epoxy compound (100 parts by mass) |
| Photopolymerization | cationic photopolymerization initiator |
| initiator | (10 parts by mass) |
| Solvent | 70 parts by mass |
| Coating method | spray coating |
| Average thickness of | 15 μm |
| coating film | |
| Standing before | at 25° C. for 5 minutes |
| application of UV | (solvent evaporation amount: 75% by mass) |
| rays | |
| Application of UV | applying UV of 1,000 mJ/cm² for 5 minutes |
| rays | |
| Drying | at 80° C. for 10 minutes |
| Crease | width of each polygon surrounded by large creases |
| | was 2 mm to 4 mm, pitch of creases inside thereof |
| | was 0.1 mm to 0.15 mm (the same as No. 3 of |
| | Example 2) |
| Base | largely deformed by heat generated during the |
| | application of UV rays. |
| Pencil hardness | H |
| Adhesion | 100/100 |

It was found from the results of Table 4 that the maximum width LB of each side of the region (polygon) surrounded by the large creases was 2 mm to 4 mm, the average pitch LS of the small creases was 0.1 mm to 0.15 mm, the coating film similar to No. 3 of Example 2 was obtained.

However, the housing of the mobile phone on which the coating film had been formed was largely deformed by the heat generated during the application of UV rays (see FIG. 10).

### Example 5

A ultraviolet ray curable coating material was prepared by blending 100 parts by mass of epoxy acrylate (U-PICA EPA8351, manufactured by Japan U-PICA

Company, Ltd.) as a photocurable resin, 10 parts by mass of a benzoin derivative (B0079, manufactured by Tokyo Chemical Industry Co., Ltd.) as a photopolymerization initiator, and 70 parts by mass of the following solvent.

—Solvent—

The solvent included toluene (33.2% by mass), ethyl acetate (3% by mass to 5% by mass), butyl acetate (15% by mass to 20% by mass), isobutyl alcohol (5% by mass to 10% by mass), methyl isobutyl ketone (5% by mass to 10% by mass), cyclohexanone (5% by mass to 10% by mass), ethylene glycol monobutyl ether (10% by mass to 15% by mass), and ethyl alcohol (1% by mass to 3% by mass).

The obtained coating materials was applied onto housings (ABS resin) of mobile phones, on which undercoats of 6 colors, black, blue, gray, pink, red, and white, had been applied respectively, to give a thickness of 15 μm. After leaving to stand at 25° C. for 5 minutes, ultraviolet rays of 500 mJ/cm² was applied for 5 minutes using a UV lamp (Type: H06-L31, 6 kW, manufactured by EYE GRAPHICS CO., LTD.), to forcefully contract each coating film. As a result, the thin film of the surface layer was cracked to thereby form large creases each having high height and wide width. Thereafter, each coating film was dried with hot air at 80° C. for 3 minutes. As a result, the solvent was completely evaporated, and the resin was completely cured. During this curing, inside each region surrounded by the large creases having high height and wide width, small creases having small height and aligned substantially horizontally at a substantially equal pitch within each region were formed. In the manner mentioned above, the coating films of Example 5 were produced.

Next, each of the produced coating films was subjected to the evaluations of “maximum width of each side of the region surrounded by large creases, and the average pitch of small creases,” “pencil hardness,” and “adhesion” in the same manner as in Example 1. As a result, the maximum width LB of each side of the region (polygon) surrounded by the large creases was 2 mm to 4 mm, and the average pitch LS of the small creases was 0.1 mm to 0.15 mm.

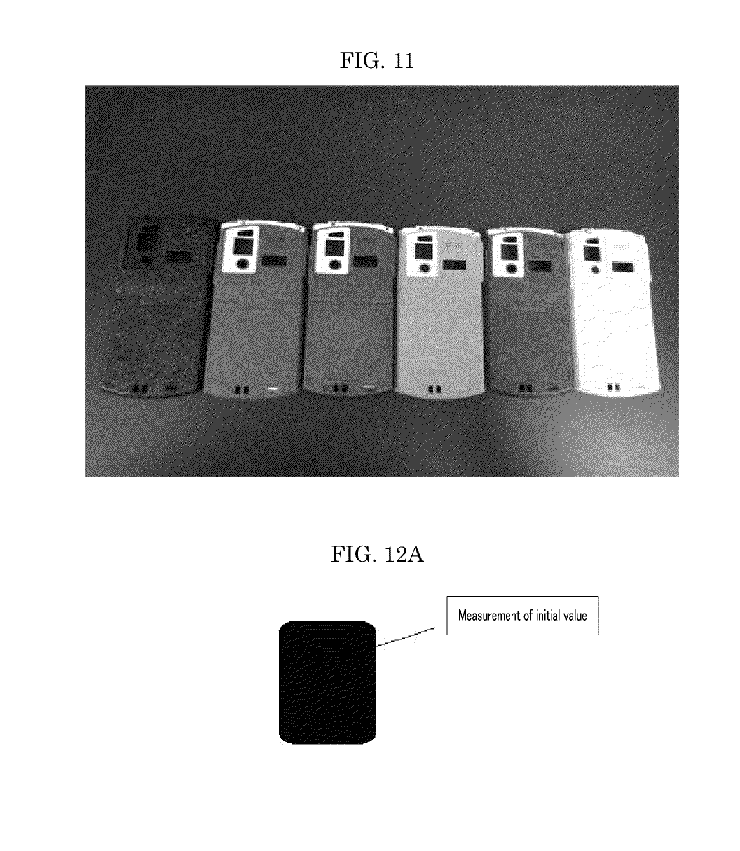

Since the coating film having the crease pattern with convexoconcave was transparent, the coating color of the under layer could be viewed. Therefore, appearances having excellent design of 6 colors, black, blue, gray, pink, red, and white from the left could be attained as depicted in FIG. 11.

Moreover, the coating films could achieve the hardness H, which was required for a coating surface of an electronic device, in the pencil hardness test, and sufficient adhesion could be attained without peeling in the adhesion test (cross-cut test). Moreover, an effect that finger prints and dirt were hard to be deposited, and a resulting equipment was hard to slip could be obtained owing to the crease pattern with convexoconcave. Furthermore, fingerprint-proof and dirt-proof were evaluated in the following manner.

### <Evaluation of Fingerprint-Proof and Dirt-Proof>

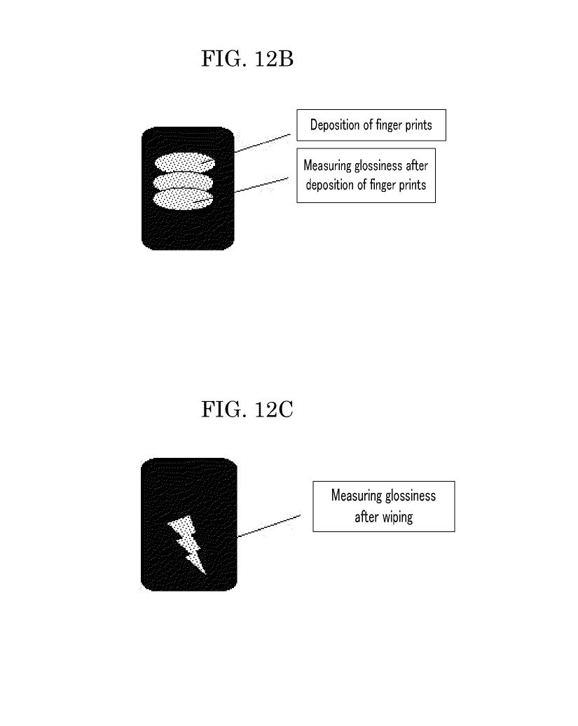

As depicted in FIGS. 12A to 12C, the coating films produced in Comparative Example 1 and Example 5 were wiped with Hize Gauze. Then, finger prints of a subject were deposited thereon, followed by drying. The deposited area was wiped with Hize Gauze 5 times in one direction, and glossiness was measured by means of a glossiness measuring device (GM-60Plus/GM-268Plus, manufactured by KONICA MINOLTA, INC.). The results are presented in Table 5.

TABLE 5

| | Evaluation | | |
|---|---|---|---|
| State | method | Comp. Ex. 1 | Ex. 5 |
| Initial | Glossimeter | 88.7 | 3.6 |
| (acquired state) | | 87.3 | 3.6 |
| | | 86.9 | 3.2 |
| | | 87.6 | 3.4 |
| | | 87.2 | 4.1 |
| | Ave. \textcircled{1} | 87.5 | 3.6 |
| [symbol] | 1σ | 0.695 | 0.335 |
| Deposition of | Glossimeter | 51.5 | 3.4 |
| finger prints | | 51.3 | 3.9 |
| (without wiping) | | 52.6 | 4.1 |
| | | 52.0 | 3.2 |
| | | 52.5 | 4.1 |
| | Ave. \textcircled{1} | 52.0 | 3.7 |
| | 1 σ | 0.581 | 0.416 |
| | Appearance | Confirmed | Cannot confirm |
| [symbol] | evaluation | finger prints | finger prints |
| After wiping | Glossimeter | 82.2 | 2.9 |
| finger prints | | 81.3 | 3.7 |
| (strongly | | 80.3 | 4.1 |
| wiping with | | 80.1 | 3.5 |
| Hize Gauze 5 | | 79.7 | 3 |
| times in one | | 79.3 | 4.5 |
| direction) | | 79.6 | 3.9 |
| | Ave. \textcircled{2} | 80.4 | 3.7 |
| | 1 σ | 1.039 | 0.577 |
| | Appearance | Confirmed | Cannot confirm |
| | evaluation | finger prints | finger prints |

| | | |
|---|---|---|
| Antifouling recovery rate(\textcircled{2}/\textcircled{1})) | 91.8% | 102.2% |

From the results of Table 5, the glossiness of the coating film of Example 5 did not change by the finger prints and dirt compared to the coating film of Comparative Example 1, and the change thereof could not also be confirmed visually. However, diffused reflection was caused by the crease pattern with convexoconcave, and therefore the value of glossiness was not stabilized. Looking at microscopically, gloss was observed, but the average value in the measuring area (10 mm×10 mm) of the glossimeter was small. Accordingly, it was found that Example 5 had an effect that finger prints and dirt were hard to be deposited compared to Comparative Example 1.

The disclosed method for producing a coating film and the disclosed coating film gives or has a crease pattern with convexoconcave, and texture, can realize a design, which has not seen before, such as a mother-of-peal style, and a crystal style, as well as hardly depositing finger prints and dirt, and hardly slips, and therefore can be suitably used in various fields. For example, the disclosed method and the disclosed coating film can be suitably used for a housing of an electronic device, such as a laptop, and a mobile phone.

The disclosed electronic device is suitable, for example, for a mobile phone, and a laptop.

All examples and conditional language provided herein are intended for pedagogical purposes to aid the reader in understanding the invention and the concepts contributed by the inventor to further the art, and are not to be construed as limitations to such specifically recited examples and conditions, nor does the organization of such examples in the specification related to a showing of the superiority and inferiority of the invention. Although one or more embodiments of the present invention have been described in detail, it should be understood that the various changes, substitutions, and alterations could be made hereto without departing from the spirit and scope of the invention.

1. A method for producing a coating film, comprising:
coating a base with a coating material containing a photocurable resin, a photopolymerization initiator, and a solvent;
leaving the coated base to stand for longer than 0 minutes but 20 minutes or shorter at 50° C. or lower; and
then applying ultraviolet rays to the coated base to thereby produce a coating film on the base.

2. The method according to claim 1, wherein the leaving is leaving the coated base to stand for longer than 0 minutes but 15 minutes or shorter at 15° C. to 35° C.

3. The method according to claim 1, wherein the ultraviolet rays are applied at 800 mJ/cm² or lower for 1 minute to 20 minutes.

4. The method according to claim 1, wherein an amount of the solvent evaporated from the coating film before applying ultraviolet rays is 50% by mass or less.

5. The method according to claim 1, wherein the photocurable resin is an acryl-based resin.

6. The method according to claim 1, wherein the coating film has convex portions, and an average thickness of the convex portions of the coating film is 10 μm to 50 μm.

7. A coating film, obtained by the method comprising:
coating a base with a coating material containing a photocurable resin, a photopolymerization initiator, and a solvent;
leaving the coated base to stand for longer than 0 minutes but 20 minutes or shorter at 50° C. or lower; and
then applying ultraviolet rays to the coated base to thereby produce a coating film on the base.

8. A coating film, comprising:
a crease pattern with convexoconcave,
wherein the coating film is obtained by the method containing:
coating a base with a coating material containing a photocurable resin, a photopolymerization initiator, and a solvent; and
then applying ultraviolet rays to the coated base to thereby produce the coating film on the base,
wherein the crease pattern with convexoconcave has large creases and small creases, where a maximum width of each side of a region surrounded by the large creases is 1 mm to 8 mm, and the small creases are provided at an average pitch of 0.1 mm to 0.4 mm inside each region surrounded by the large creases.

9. The coating film according to claim 8, wherein the coating film having the crease pattern with convexoconcave is transparent.

10. An electronic device, comprising:
a coating film having a crease pattern with convexoconcave,
wherein the coating film is obtained by the method containing:
coating a base with a coating material containing a photocurable resin, a photopolymerization initiator, and a solvent; and
then applying ultraviolet rays to the coated base to thereby produce the coating film on the base,
wherein the crease pattern with convexoconcave has large creases and small creases, where a maximum width of each side of a region surrounded by the large creases is 1 mm to 8 mm, and the small creases are provided at an average pitch of 0.1 mm to 0.4 mm inside each region surrounded by the large creases.
